(19) United States
(12) Patent Application Publication
(10) Pub. No.: US 2019/0253551 A1
(43) Pub. Date: Aug. 15, 2019

(54) Method To Reduce Mobile Telephone Charges By Immediate Disconnect And Redial

(71) Applicant: QUALCOMM Incorporated, San Diego, CA (US)

(72) Inventors: Srinivasarao PASUMARTHI, Hyderabad (IN); Sudheer Kumar Reddy Vangala, Hyderabad (IN); Dheeraj Kumar, Hyderabad (IN); Mohd Abdullah Sami, Hyderabad (IN)

(21) Appl. No.: 16/269,391

(22) Filed: Feb. 6, 2019

Related U.S. Application Data
(60) Provisional application No. 62/630,027, filed on Feb. 13, 2018.

(51) Int. Cl. H04M 3/424; H04W 76/27; H04M 3/42; H04M 3/20; H04L 29/06

(52) U.S. Cl. CPC H04M 3/424; H04W 76/27; H04L 65/1069; H04M 3/20; H04M 3/42195

(57) ABSTRACT

Various embodiments include methods that may be implemented on a mobile device to enable responding to an incoming mobile terminated (MT) call by promptly initiating a mobile originated (MO) call back to the calling mobile device with minimal delay. Various embodiments may include a mobile device receiving from a network a first paging request associated with a first service request for establishing a first MT call from another mobile device, activating a user interface feature for converting the first MT call to a first MO call from the mobile device to the other mobile device, sending to the network, a disconnect message with normal a clearing cause code such that the first MT call is promptly terminated, sending to the network a second service request for a second MO call to the other mobile device; and establishing the second MO call at the mobile device.

### RELATED APPLICATIONS

This application claims the benefit of priority to U.S. Provisional Application No. 62/630,027, entitled “Method To Reduce Mobile Telephone Charges By Immediate Disconnect And Redial” filed Feb. 13, 2018, the entire contents of which are hereby incorporated by reference for all purposes.

### FIELD OF THE INVENTION

The present invention relates to communication devices. More specifically, but not by way of limitation, the present invention relates to apparatus and methods for improving the user experience on mobile devices by providing immediate disconnect and redial.

### BACKGROUND

Often when a callee receives a mobile voice call perhaps from family, friends, acquaintances, or business contacts, it may be desired to avoid call charges to the caller's device. In such cases, the callee may disconnect the call and immediately attempt to call the caller back to therefore assume the costs of the calls. On many communication systems the act of disconnecting the original call results in the network generating a “user busy” response, invoking a voice message played repeatedly advising the callee that the dialed number to the caller is busy and to try again after some time. Such a voice message may last upwards of 30 seconds and, further, prevent any other incoming calls to the callee. There is therefore a need in the industry for more efficient methods and apparatus enabling a callee to immediately call back to a caller without triggering a long user busy response.

### SUMMARY

Various embodiments include methods that may be implemented on a mobile device to enable responding to an incoming telephone call, referred to as a mobile terminated (MT) call, by promptly initiating a mobile originated (MO) call back to the calling mobile device (the “first mobile device) with minimal delay. Various embodiments may include the receiving mobile device (the “second mobile device”) receiving from a network a first paging request associated with a first service request for establishing a first MT call from a first mobile device, activating a user interface feature for converting the first MT call from the first mobile device to a first MO call from the second mobile device to the first mobile device, sending to the network a disconnect message such that the first MT call is promptly terminated, sending a second service request for a second MO call from the second mobile device to the first mobile device, and establishing the second MO call at the second mobile device.

Some embodiments may further include the first mobile device sending to the network the first service request for establishing the first MO call at the first mobile device, receiving a normal disconnect in response to sending the first service request for establishing the first MO call at the first mobile device, receiving from the network a second paging request associated with the second service request to establish a second MT call by the first mobile device with the second mobile device. Some embodiments may further include the first mobile device automatically accepting the second MO call in response to receiving the second paging request associated with the second MT call after sending the first service request for establishing the first MO call.

In some embodiments, sending the disconnect message such that the first MT call is promptly terminated may include sending a call control disconnect message with a normal clearing cause code, and sending a call control release message.

In some embodiments, sending the disconnect message such that the first MT call is promptly terminated may include releasing a radio resource control (RRC) connection associated with the first MT call in response activating the user interface feature for converting the first MT call at the second mobile device to the second MO call to the first mobile device.

In some embodiments, activating the user interface feature for converting the first MT call from the first mobile device to a first MO call from the second mobile device to the first mobile device may include the second mobile device displaying a user interface button configured to generate a user input for trigging a conversion of an MT call to a MO call. In some embodiments, sending the disconnect message to the network may be performed in response to receiving a user input from the displayed user interface button. In some embodiments, displaying the user interface button configured to generate the user input for trigging the conversion of the MT call to the MO call may be performed in response to receiving the first paging request associated with the first service request for establishing the first MT call from the first mobile device.

Further embodiments may include a mobile device including a transceiver, and processor coupled to the transceiver and configured with processor-executable instructions to perform operations of any of the methods summarized above. Further embodiments may include a non-transitory processor-readable storage medium having stored thereon processor-executable instructions configured to cause a processor of a mobile device to perform operations of any of the methods summarized above. Further embodiments may include a mobile device having means for performing functions of any of the methods summarized above.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain features of the invention.

FIG. 1 is a block diagram illustrating a system suitable for implementing the various embodiments.

FIG. 2 is an illustration of a mobile device user interface (UI) that is suitable for use in converting a mobile terminated (MT) call to a mobile originated (MO) call in accordance with some embodiments.

FIG. 3 is a call flow diagram illustrating various operations and communications between components in a system configured to convert a MT call to a MO call in accordance with some embodiments.

FIG. 4 is a block diagram illustrating various components and communications in a system suitable for implementing the various embodiments.

FIGS. 5 and 6 are illustrations of sample call logs that demonstrate conventional methods for ending an incoming mobile terminated call and initiating a new outgoing mobile originated call.

FIG. 7 is an illustration of a sample call log that demonstrates benefits associated with converting a mobile terminated call to a mobile originated call in accordance with various embodiments.

FIG. 8 is a process flow diagram illustrating a system method of converting a mobile terminated call to a mobile originated call in accordance with various embodiments.

FIGS. 9A and 9B are process flow diagrams illustrating methods of converting a request for a mobile terminated call to a mobile originated call in accordance with various embodiments.

FIG. 10 is a processor flow illustrating a method for automatically accepting a mobile terminated call in response to initiating a mobile originated call in accordance with an embodiment.

FIG. 11 is a communication system block diagram illustrating network components of an example telecommunication system suitable for use with various embodiments.

FIG. 12 is a component block diagram illustrating components of a mobile device that may be configured to implement various embodiments.

FIG. 13 is a component block diagram of a mobile device in the form of a smartphone that may be configured to implement various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

Various embodiments include methods and mobile devices implementing the methods that enable a user of a mobile device (“second mobile device”) to respond to an incoming telephone call (i.e., MT call) by promptly initiating an MO call back to the calling mobile device (the “first mobile device) in a manner that reduces delay in establishing the call back. When a paging request for an incoming MT call is received, the receiving mobile device (second mobile device) may display a user interface prompt that provides the user with an option of selecting an immediate call back to the originating mobile device in a manner that effectively converts the incoming MT call to an outgoing MO call. This option may be useful in situations in which the user would prefer charges for the call to on the account of the user's mobile device instead of the account of the mobile device originating the call (the first mobile device). In response to the user selecting that option (e.g., pressing a button on a displayed graphical user interface), the second mobile device may send a disconnect message to the wireless network that causes the network to immediately terminate the incoming MT call. After sending the disconnect message, the second mobile device may immediately initiate an outgoing MO call to the first mobile device, such as by sending a service request message to the wireless network. Because the incoming MT call is terminated at the network by the disconnect message, the return MO call can go through immediately to the first mobile device so the user of the second mobile device will not hear a busy signal and have to wait several seconds before placing the call back MO call. When the MO call is answered by the first mobile device, the call may be established between the first and second mobile devices.

The term “mobile device” is used herein to refer to any one or all of cellular telephones, smartphones, personal or mobile multi-media players, laptop computers, tablet computers, ultrabooks, smartbooks, netbooks, palm-top computers, wireless electronic mail receivers, multimedia Internet enabled cellular telephones, cellular enabled motor vehicles, wearable computing devices (e.g., smart watches, etc.), and similar electronic devices which include a programmable processor, memory and circuitry for initiating and receiving mobile or cellular telephone calls. While various embodiments are particularly useful in wireless devices, such as smartphones, the embodiments are generally useful in any electronic device that includes communication circuitry for accessing services through cellular and wireless communication networks.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA2000™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iden). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Telecommunication service providers offer their customers a wide array of subscription plans, including pre-paid plans, flat-rate plans, actual usage plans, unlimited usage plans, post-paid plans, usage-limited plans, multi-user plans, and various other plans based on the amount of bandwidth, voice, text, data, and/or other services used per billing period. Under many of these subscription plans, the costs and services associated with a mobile originated (MO) call is not the same as those associated with mobile terminated (MT) call. That is, the subscriber account associated with the MO call (i.e., the account of the calling party) is often charged for the call, whereas the subscriber account associated with corresponding MT call (i.e., the account of the called party) is not charged at all. Various embodiments allow the called party to quickly, efficiently, and automatically convert a MT call to a MO call, thereby providing the called party with more control over the charges and services associated with the call.

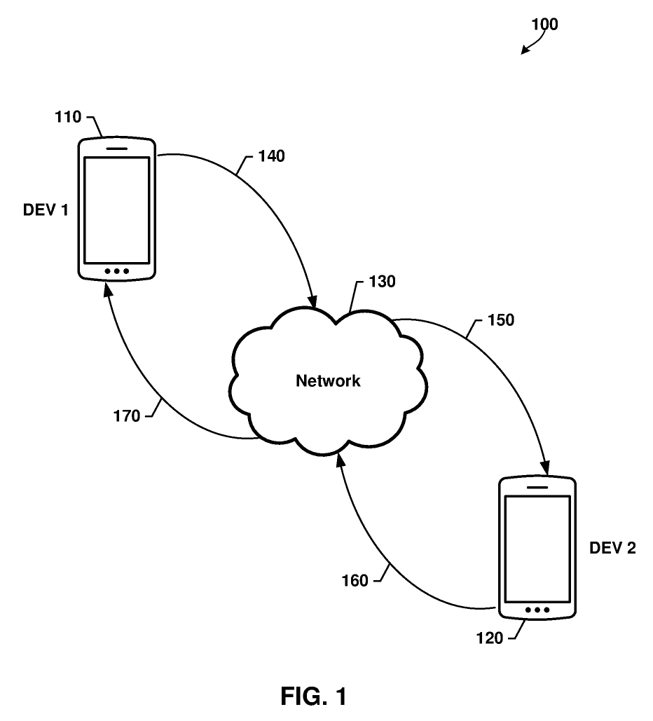

FIG. 1 depicts an overview of a system 100 configured to implement various embodiments as disclosed herein. A user operating a first mobile device 110 may wish to establish a voice communication with another user operating a second mobile device 120. A mobile originated (MO) call is initiated at the first mobile device 110 resulting in a service request 140 sent to the network 130, in response to which the network 130 sends a paging request 150 to a second mobile device 120 to establish a mobile terminated (MT) call at that end. In various embodiments the user of the second mobile device 120 ends the call and immediately calls the user at first mobile device 110 back to assume the call charges, for example, instead of the call charges being billed to the user at the first device 110. It will be appreciated that other motivations for an implementation of embodiments described herein may apply. Accordingly, a service request 160 is sent to the network 130, in response to which the network 130 sends a paging request 170 to the first mobile device 110. The new MT call may then be instantiated at the first mobile device 110.

Embodiments provide for a user interface on the second mobile device 120 which, when activated, allows the user to immediately end the MT call when it is received and to initiate a new MO call to the first mobile device 110. In many situations, immediately ending the MT call as described may eliminate time-consuming, unnecessary, and undesired user busy messages sent to the user of the second mobile device 120 after that user ends the MT call. Such user busy messages impede a timely call back to the user at the first mobile device 110 and may cause useless connection time during the message playback to be charged to the user at the first mobile device 110 if the incoming MT call is routed to voice mail by the network while the user of the second mobile device 120 attempts the call back. Various embodiments may be implemented through uses and/or modifications to such communication protocols as, for example, Session Initiation Protocol (SIP) and/or IP Multimedia Subsystem (IMS). However, it will be appreciated that the concepts disclosed herein may apply in equal force to other communication protocols and that SIP and IMS are mentioned here merely as a non-limiting example.

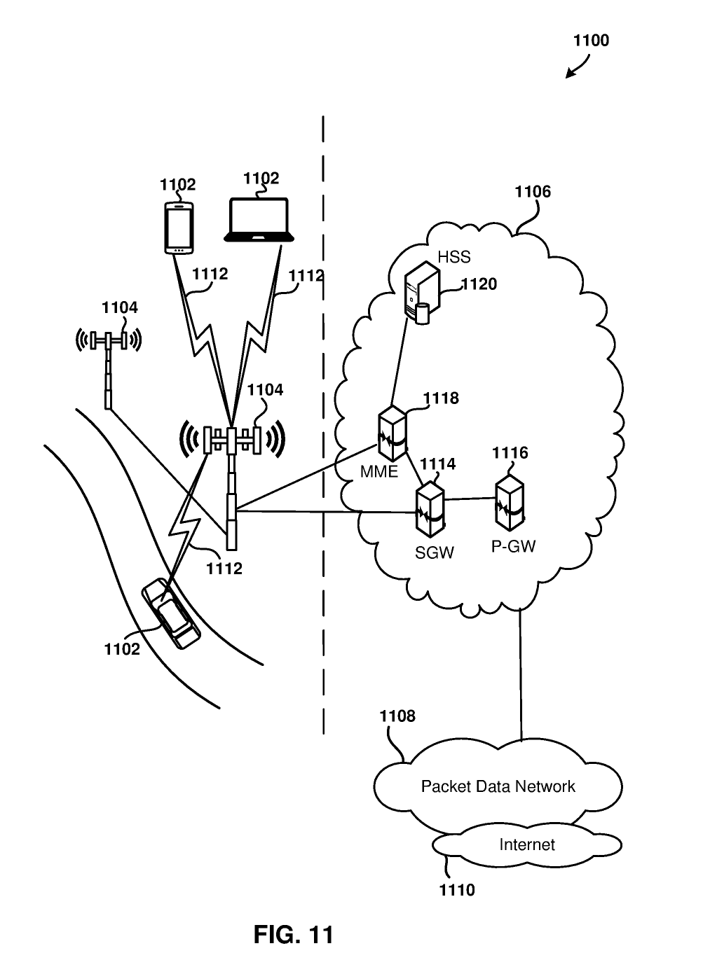

In some embodiments, the network 130 may include network servers connected to a cellular telephone network and/or to the Internet. A typical telephone network includes a plurality of cell base stations coupled to a network operations center, which operates to connect voice calls and data between mobile devices 110, 120 and other network destinations, such as via telephone land lines (e.g., a plain old telephone system (POTS) network, not shown) and the Internet. Communications between the mobile devices 110, 120 and the telephone network may be accomplished via two-way wireless communication links, such as 5G, 4G, 3G, CDMA, TDMA, LTE and/or other cell telephone communication technologies. The telephone network may also include one or more servers coupled to or within the network operations center that provide a connection to the Internet. Further details regarding the network 130 are described below with reference to FIG. 11.

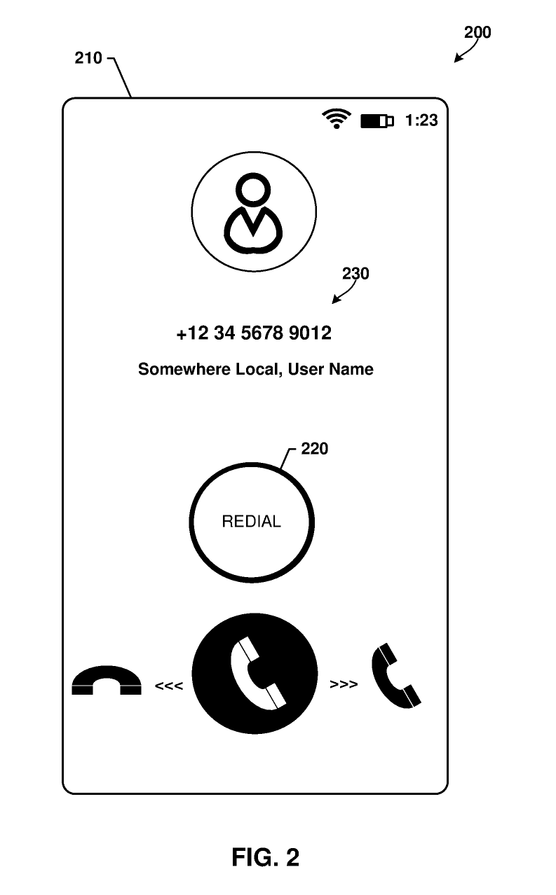

FIG. 2 depicts a typical user interface (UI) 200 that may be displayed on a mobile device (e.g., mobile device 120 illustrated in FIG. 1), associated with a mobile communications application, and including a graphical user interface (GUI) 210. Embodiments described herein provide for a UI feature rendered as part of the GUI 210, such as a redial button 220 and caller information 230. The caller information 230 may enable a user to recognize the originator of the call, and thus decide whether to implement various embodiments in order to complete the call on the user's account. In the illustrated example, the redial button 220 provides a user with a one-touch interface to initiate a call back to convert the incoming MT call to an outgoing MO call according to various embodiments.

It will be appreciated that the UI feature rendered as a redial button 220 is only an example, and that many different forms for this UI feature may be used with functional equivalence to the redial button 220 as depicted. Therefore, the redial button 220 discussed herein will be understood to represent any other such forms for this UI feature.

In an embodiment, when an incoming MT call is fielded by the mobile device 120, the user is notified conventionally of the call by the GUI 210, and a redial button 220 is rendered in the GUI 210. Upon activating the redial button 220, the incoming MT call is immediately ended, and a new MO call is initiated for connection with the original caller.

In various embodiments, the UI feature or redial button 220 may be implemented as a soft key button, hard key button, touch key, or any other way of receiving user input. As described more fully below, the mobile device 120 may include a processor configured to activate or render the redial button 220 within the GUI 210 on an electronic display of the mobile device 120 in response to detecting an incoming MT call, such as receiving a paging request. The processor receives a user input when the user touches the redial button 220, and in response may immediately end the incoming MT call by sending a disconnect message to the network 130 and initiate a new MO call with the original caller.

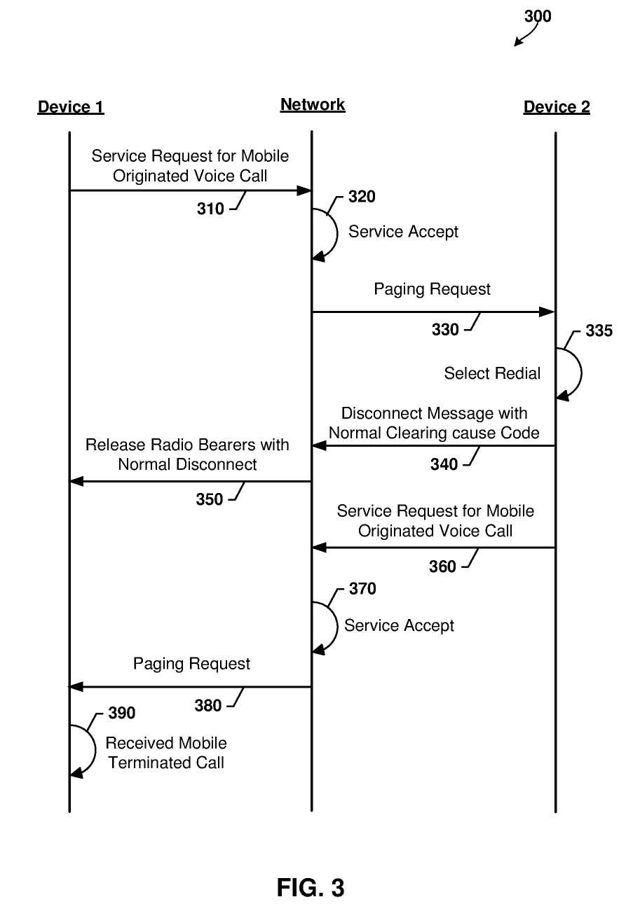

FIG. 3 is a sequential flowchart 300 depicting signal flows according to various embodiments described here. A Device 1 (such as first mobile device 110 in FIG. 1) sends a service request 310 for an MO voice call, which is at a Network (e.g., network 130) in operation 320, resulting in a paging request 330 to a Device 2 (e.g., second mobile device 120). Upon receiving the paging request, and before an MT call may be established at Device 2, the user of Device 2 may select redial 335 by activating a redial button displayed at Device 2 (e.g., redial button 220). A disconnect message with normal clearing cause code 340 may be sent and received at the Network, resulting in a release message 350 sent to Device 1. In some embodiments, sending the disconnect message with normal clearing cause code 340 may include sending a call control disconnect message and/or sending a call control release message. In some embodiments, sending the disconnect message with normal clearing cause code 340 may include releasing a radio resource control (RRC) connection associated with the first MT call in response activating the user interface feature for converting the first MT call at the second mobile device to the second MO call to the first mobile device. A service request 360 for a MO call at Device 2 is automatically sent and accepted at the Network in operation 370, following which a paging request 380 is sent to Device 1 to establish an MT call at that end. The MT call is then received in operation 390.

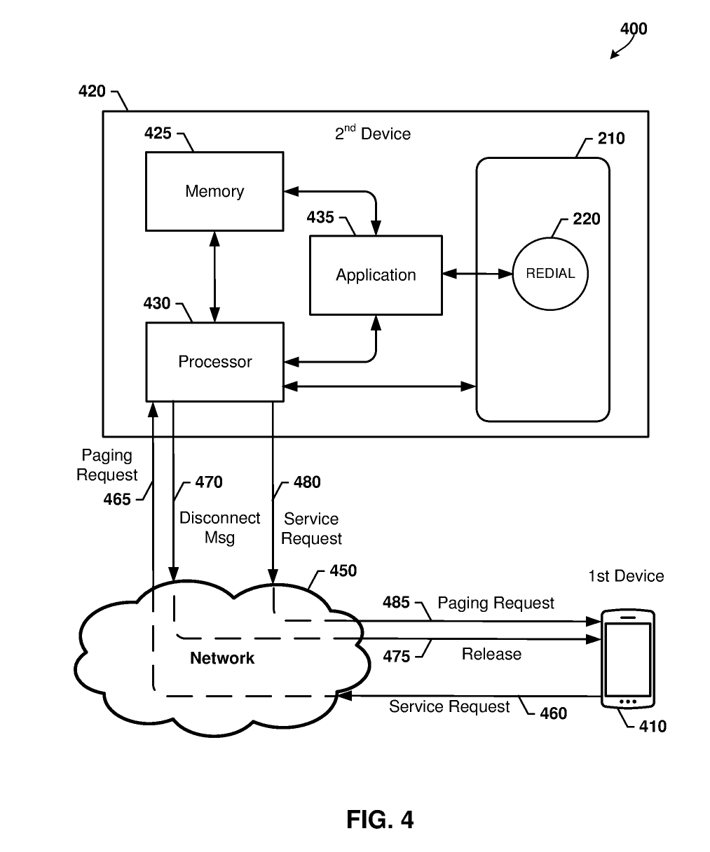

FIG. 4 depicts a system 400 and a mobile device apparatus (i.e., second device 420) for performing various embodiments described herein. Shown are a first mobile device 410, a network 450, and a second mobile device 420. In an embodiment, the second device 420 comprises at least a GUI 210 including a UI feature that may be rendered as a redial button 220, a memory 425, and a processor 430. The processor 430 is functionally coupled with the memory 425 and the GUI 210 including the redial button 220. An application 435 may include voice call functionality, and the redial button 220 may be functionally coupled thereto. It will be understood that some components described with respect to FIG. 4 may be realized in hardware, software in connection with hardware, firmware, or a combination thereof. Moreover, the first mobile device 410 and the second mobile device 420 may be any of a variety of devices such as smartphones, netbooks, gaming devices, PDAs, tablets, and laptop computers. Further, various hardware components may be implemented as parts of a system on a chip (SoC).

A user of the first mobile device 410 may initiate a mobile originated (MO) call, causing the first mobile device 410 to send a service request 460 to the network 450. The processor 430 of the second mobile device 420 may be configured to receive a paging request 465 associated with the service request 460 from the network 450 to initiate a mobile terminated (MT) call at the second mobile device 420. Upon receiving the paging request 465, the processor 430 and/or application 435 may access the memory 425 for contact information relating to the user of the first mobile device 410, for example, indicated in the paging request, to be displayed in by the GUI 210. Using that information, the application 435 may thus notify a user of the second mobile device 420 that an incoming voice call is awaiting, and from whom the call originated. The user may activate the redial button 220, causing the application 435 to instruct the processor 430 to disconnect the incoming MT call immediately. In various embodiments, this may be accomplished by the processor 430 sending a disconnect message 470 to the network 450, though one skilled in the art may appreciate that other methods and means are applicable. In some embodiments, sending the disconnect message 470 may include sending a normal clearing cause code, a call control disconnect message and/or sending a call control release message. In some embodiments, sending the disconnect message 470 may include releasing a radio resource control (RRC) connection associated with the first MT call in response activating the user interface feature for converting the first MT call at the second mobile device to the second MO call to the first mobile device. In some embodiments, a SIP BYE message may be sent to invoke a disconnect (possibly in an alternative usage in which an MT call session need not yet be established). A release message 475 associated with the disconnect message 470 may then be sent by the network 450 to the first mobile device 410. The application 435 may then instruct the processor 430 to instantiate a new MO call from the second mobile device 420, following which the processor 430 may send a service request 480 to the network 450. The first mobile device 410 may then receive a paging request 485 associated with the service request 480, accept the service, and subsequently instantiate a new MT call with the second mobile device 420.

Although some components depicted in FIG. 4 represent physical components, FIG. 4 is not intended to be a detailed hardware or software diagram. Thus, many of the components depicted in FIG. 4 may be realized by common constructs or be distributed among additional physical components. Moreover, it is contemplated that other existing and yet-to-be developed physical components and architectures may be utilized to implement the functional components described with reference to FIG. 4.

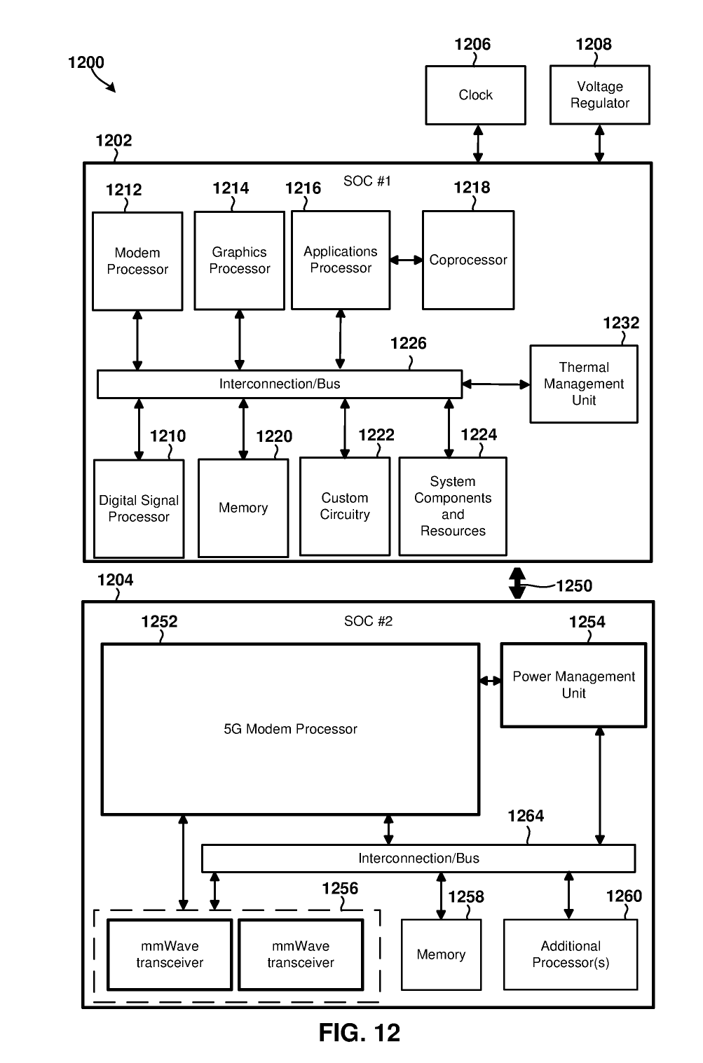

Further, while FIG. 4 depicts an example of constructs that may be utilized to implement embodiments disclosed herein, the various illustrative logical blocks, modules, and methods described in connection with the embodiments disclosed herein may be implemented or performed in a variety of different ways. For example, the various illustrative logical blocks, modules, and methods described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A generally purposed processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Further details regarding processors that may implement various embodiments are described below with reference to FIG. 12.

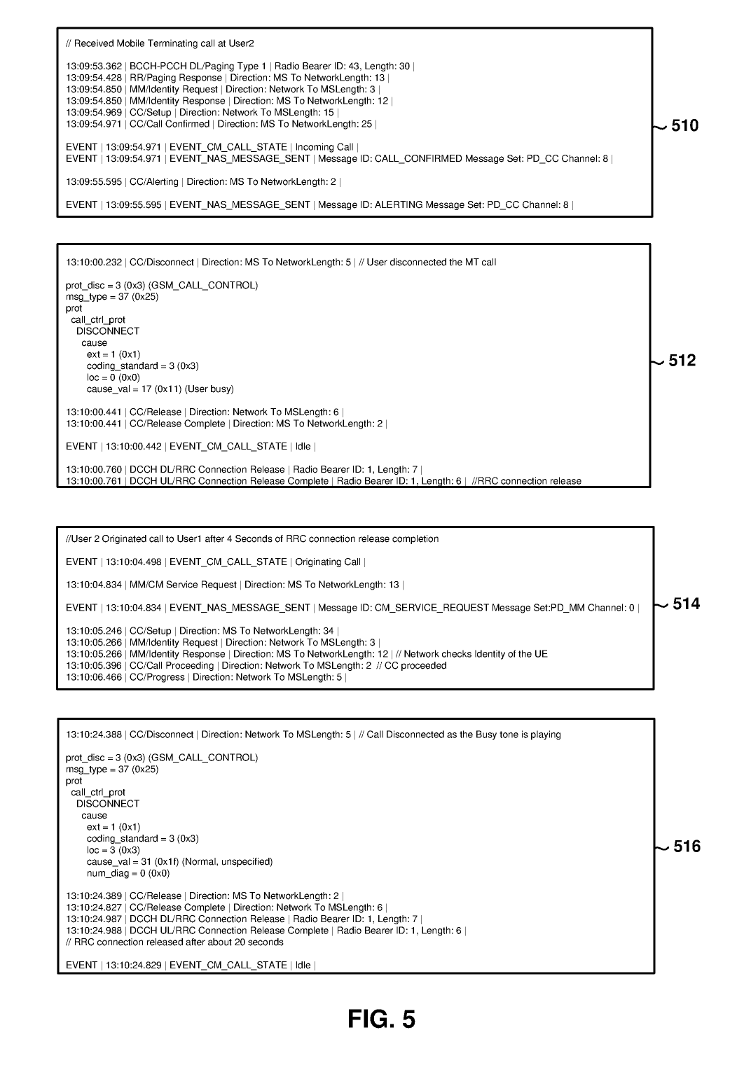

FIGS. 5 through 7 are illustrations of sample call logs that demonstrate differences between two conventional methods and an embodiment.

With reference to FIG. 5, block 510 shows a log of call operations and messages when User1 (i.e., a user of a first mobile device 110) calls User2 (i.e., a user of a second mobile device 120). Block 512 shows a log of call operations and messages when User2 disconnects the call. Block 514 shows a log of call operations and messages when User2 dials back to User1 after 4 seconds. Block 516 shows a log of call operations and messages when User2 attempts to connect to User1 through the network for about 20 seconds. However, because User1 is listening to the user busy response (e.g., “ . . . the user is busy, please call after some time . . . ”) the call back cannot be completed. Further, another message is initiated to User2 (e.g., “ . . . the user is on another call, please try again in a while”) for a 20 second duration, thus occupying valuable user equipment (UE) and network resources such as power and time, etc. Sometimes the user busy response may be much longer, requesting the caller to leave a voicemail, complete with instructions as to how to do so. These types of user busy responses may thus cause long delays before a call back can be completed. Moreover, in some regions the user busy responses may play in multiple languages, further lengthening the delay before the call back can be completed. For callers in India, in an example, the user busy responses may play in multiple languages including a local language, a national language, and English, thus taking longer and occupying even more resources that a user may be paying for. Indeed, one user may be listening to a user busy message such as “user busy call after some time” while the other user listens to a similar user busy message at the same time. Subsequent attempts at calling each other again may result in both users trapped in a loop for some time, causing a deteriorated user experience or perhaps a dangerous situation when emergent circumstances exist.

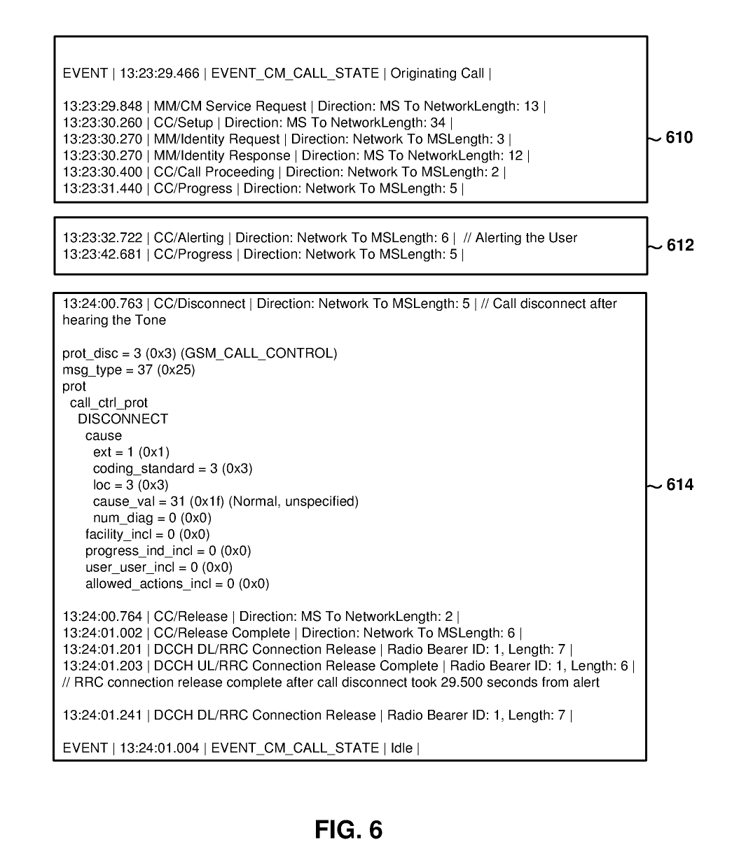

FIG. 6 shows call logs of call operations and messages under different circumstances of a call back attempt. Block 610 shows a log of call operations and messages when User1 calls User2. Block 612 shows a log of call operations and messages when User2 is alerted about the incoming call, such as by the presentation of a user interface announcement as illustrated in FIG. 2. Block 614 shows a log of call operations and messages when User2 disconnects the call immediately after being alerted of the incoming call. As illustrated in FIG. 6, the normal operations for originating the call in block 610, alerting User2 of the call in block 612, and disconnecting the call and releasing the radio bearers are lengthy. The time in between alerting User2 in block 612 (timestamp 13:23:32.722) and completing the RRC Connection Release process to release the radio bearers in block 614 (timestamp 13:24:01.203) is 29.5 seconds.

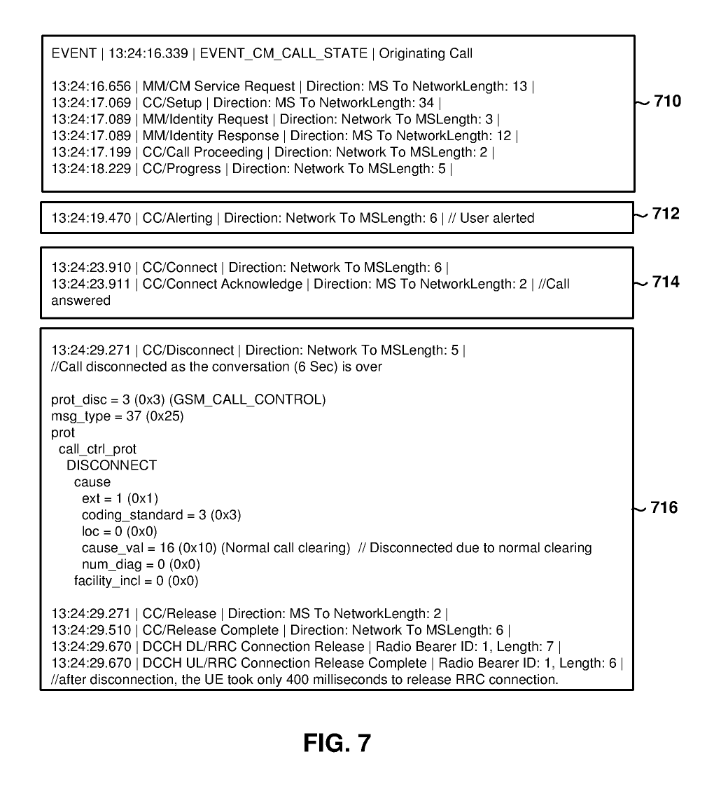

FIG. 7 shows call logs of call operations and messages under different circumstances of a call back attempt. Block 710 shows a log of call operations and messages when User1 calls User 2. Block 712 shows a log of call operations and messages when User2 is alerted on the incoming call. Block 714 shows a log of call operations and messages when User2 answers the call. Block 716 shows a log of call operations and messages when the call is disconnected. In this example, the time between alerting User2 in block 712 (timestamp 13:24:19.470) and releasing the RRC connection in block 716 (timestamp 13:24:29.670) reduces from 29.500 seconds to 400 milliseconds. Accordingly, when the user dials back immediately the call may be established unless the user calls within 400 milliseconds. In this way, establishment of a call is successful if the user dials in during the 29.500 seconds unless user triggers in the 400 milliseconds duration. The probability that the user calls within 400 milliseconds out of 29.500 s is 0.4/29.5=0.0135, or 1.35%, which is a measure of call establishment failure. The probability of successful call establishment, i.e., the user triggers the call in between 400 milliseconds and 29.500 seconds, is 1-0.0135=0.9864, or 98.64%.

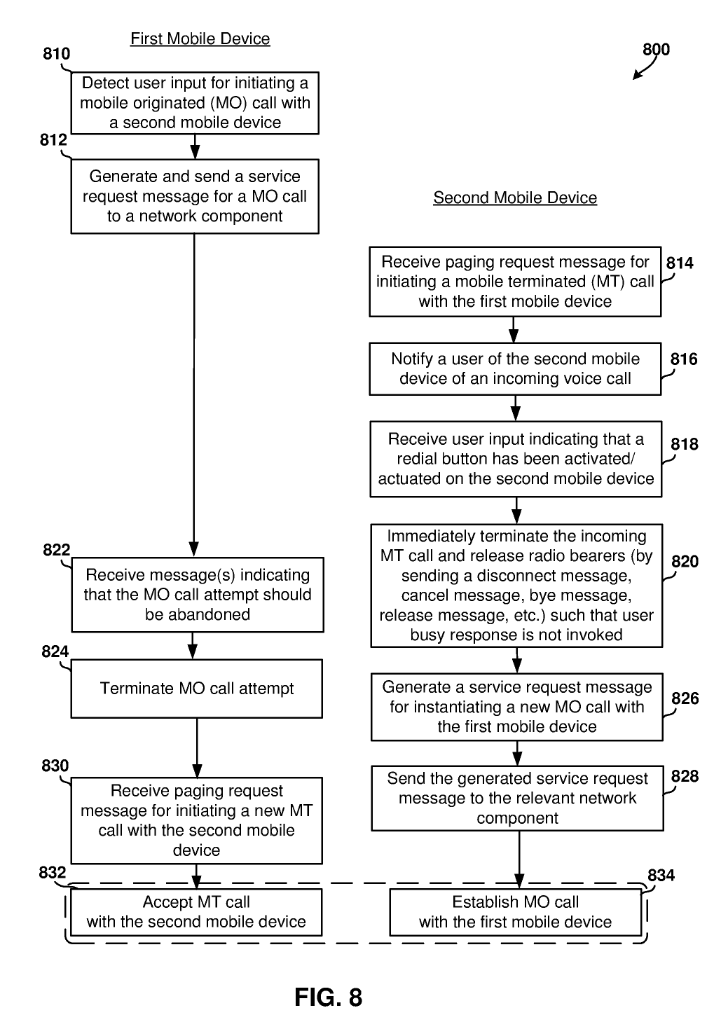

FIG. 8 illustrates a method 800 of converting a mobile terminated call to a mobile originated call in accordance with an embodiment. All or portions of the method 800 may be performed by a processor in a first mobile device (e.g., first mobile device 110 in FIG. 1, Device 1 in FIG. 3, 1^{st} Device 410 in FIG. 4, etc.) associated with a first user, and a processor in a second mobile device (e.g., second mobile device 120 in FIG. 1, Device 2 in FIG. 3, 2nd Device 420 in FIG. 4, etc.) associated with a second user.

In block 810, the first mobile device may detect user input (e.g., of the first user, etc.) for initiating a mobile originated (MO) call with the second mobile device. In block 812, the first mobile device may generate and send a service request message for a MO call to a network component (e.g., base station, network server, etc.) within a communications network (e.g., network 150 illustrated in FIG. 1, etc.). The service request message may request establishing a call between the first mobile device and the second mobile device.

In block 814, the second mobile device may receive a paging request message from the network for initiating a mobile terminated (MT) call with the first mobile device. The received paging request message may be sent by the network in response to the service request message sent in block 812. The received paging request message may request establishing an MT call at the second mobile device with the first mobile device.

In block 816, the second mobile device may notify a user of the second mobile device (e.g., second user, etc.) of an incoming voice call. In some embodiments, this may be accomplished by rendering a UI screen, GUI, and/or UI feature (e.g., UI 200, GUI 210 and/or redial button 220 illustrated in FIG. 2) on an electronic display of the second mobile device. In some embodiments, the second mobile device may also enable for activation a user interface feature (e.g., redial button 220 illustrated in FIGS. 1, 2 and 4) for converting the MT call from the first mobile device to a MO call to the first mobile device in block 816.

In block 818, the second mobile device may receive a user input indicating that a redial button has been touched/actuated on the second mobile device.

In block 820, the second mobile device may perform various operations to immediately terminate the incoming MT call and release radio bearers so that a user busy response is not generated by the network. In some embodiments, the operations for immediately terminating the incoming MT call in block 820 may include the second mobile device sending a disconnect message with normal clearing cause code to the network that prompts the network to terminate the attempt to establish a call without transmitting a user busy response to the first mobile device. In some embodiments, the operations in block 820 may include sending any or all of a cancel message, bye message, or release message so that a user busy response is not invoked by the network.

In block 822, the first mobile device may receive one or more messages from the network performing a normal disconnect and/or indicating that the MO call attempt should be abandoned. In block 824, the first mobile device may terminate the MO call attempt receive notice that the network has terminated the call attempt.

In block 826, the second mobile device may generate a service request message for instantiating a new MO call to the first mobile device. In block 828, the second mobile device may send the generated service request message for instantiating a new MO call with the first mobile device to a network component within the network.

In block 830, the first mobile device may receive a paging request message from the network for initiating a new MT call with the second mobile device. The received paging request message may be sent by the network in response to the service request message sent in block 828. The received paging request message may request establishing an MT call at the first mobile device with the second mobile device.

In block 832, the first mobile device may accept the MT call with the second device. In block 834, the second mobile device may establish a MO call with the first mobile device.

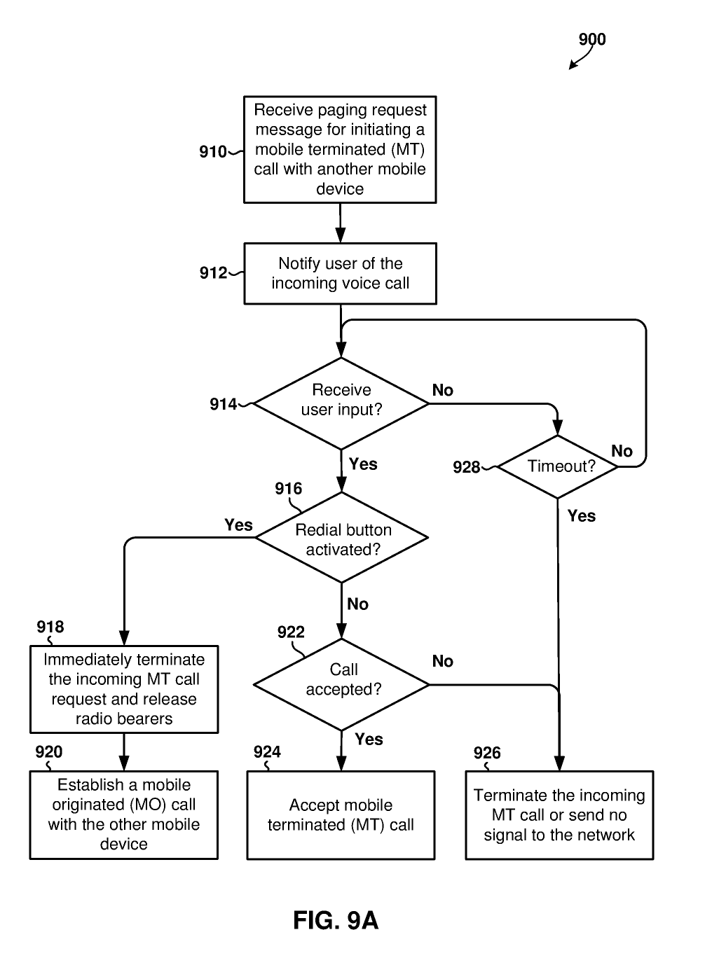

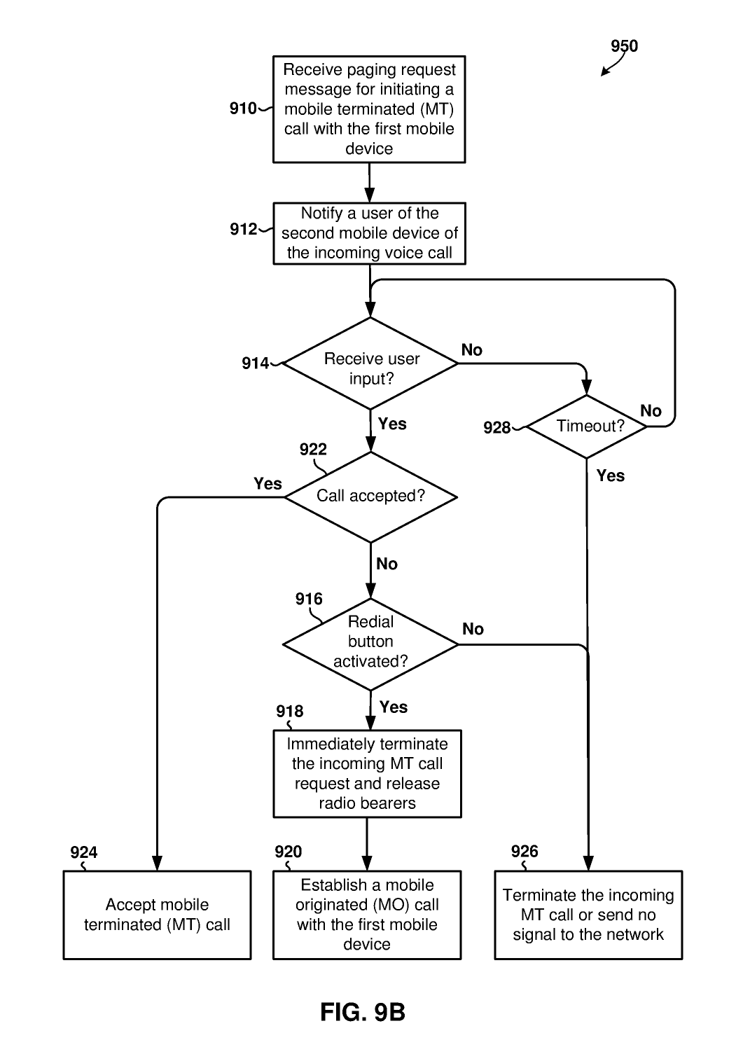

FIGS. 9A and 9B illustrate methods 900 and 950 for converting a request for a mobile terminated call to a mobile originated call in accordance with various embodiments. Methods 900 and 950 may be performed by a processor in a mobile device (e.g., second mobile device 120 in FIG. 1, Device 2 in FIG. 3, 2nd Device 420 in FIG. 4, etc.).

With reference to FIG. 9A, in block 910, the mobile device may receive a paging request message from a network (e.g., network 150 illustrated in FIG. 1, etc.) for initiating a mobile terminated (MT) call with another mobile device (e.g., first mobile device 110 in FIG. 1, Device 1 in FIG. 3, 1^{st} Device 410 in FIG. 4, etc.).

In block 912, the mobile device may notify a user of the mobile device of the incoming voice call. In some embodiments, in block 912 the mobile device may perform any or all of the operations discussed above with reference to block 816 (illustrated in FIG. 8). For example, the mobile device may render or enable a UI feature (e.g., redial button 220 illustrated in FIG. 2) on an electronic display of the second mobile device.

In determination block 914, the mobile device may monitor the user interface of the mobile device to determine whether it has detected or received a user input related to the call, such as input indicating that a call accept button, a call reject button, or a redial button rendered on the electronic display via the GUI was activated/actuated by the user.

In response to determining that user input has been received/detected (i.e., determination block 914=“Yes”), the mobile device may determine based on the user input whether the redial button was touched/actuated by the user in determination block 916.

In response to determining that the redial button was touched/actuated by the user (i.e., determination block 916=“Yes”), the mobile device may immediately terminate the incoming MT call request and release the radio bearers in block 918. In some embodiments, operations in block 918 may include sending to the network a call control disconnect message (e.g., disconnect message with normal clearing cause code 340 of FIG. 3) and/or sending a call control release message to the network. In some embodiments, operations in block 918 may include releasing a radio resource control (RRC) connection associated with the first MT call in response activating the user interface feature for converting the first MT call at the second mobile device to the second MO call to the first mobile device. In some embodiments, operations in block 918 may include performing operations of block 820 of FIG. 8.

In block 920, the mobile device may establish a new mobile originated call with the other mobile device. In some embodiments, in blocks 918 and 920 the mobile device may perform any or all of the operations illustrated in FIGS. 3 and 8 and described above with reference to the service request message 360 of FIG. 3 and/or operations of blocks 826, 828 and 834.

In response to determining that the redial button was not activated/actuated by the user (i.e., determination block 916=“No”), the mobile device may determine whether a call accept button was activated/actuated by the user in determination block 922. In response to determining that the call accept button was activated/actuated by the user (i.e., determination block 922=“Yes”), the mobile device may signal the network to accept the incoming mobile terminated call in block 924.

In response to determining that user input related to the call has not been detected or received in the mobile device (i.e., determination block 914=“No”), the mobile device may determine whether a ring duration has timed out in determination block 928. The ring duration is the duration that the mobile device will ring before an incoming call is terminated. So long as the ring duration has not timed out (i.e., determination block 928=“No”), the mobile device may continue to monitor the user interface to detect/receive user input in determination block 914. During this time, the user of the first mobile device will hear ringing sounds indicating that the network is waiting for a user of the called mobile device to answer the call. Determination block 928 is optional because the ring duration may be controlled solely by the network, and at the end of the ring duration the network may cease sending paging request messages to the mobile device.

In response to determining that the call has timed out (i.e., determination block 928=“Yes”), or in response to determining that that a user input declining the call was received (i.e., determination block 922=“No”), the mobile device may signal the network to terminate the incoming MT call or send no signals to the network in block 926. In some networks, the network may terminate the call attempt by the first mobile device after the ring duration and/or after receiving a call termination message and connect the caller to a voice mail service to permit leaving a voice message for the user of the mobile device. In some networks, the network may continue to send ringing sounds to the first mobile device until the caller hangs up.

FIG. 9B illustrates a method 950 of converting a request for a mobile terminated call to a mobile originated call in which the mobile device determines whether the redial button was touched/actuated by the user in determination block 916 in response to determining that the call accept button was not activated/actuated (i.e., determination block 922=“No’).

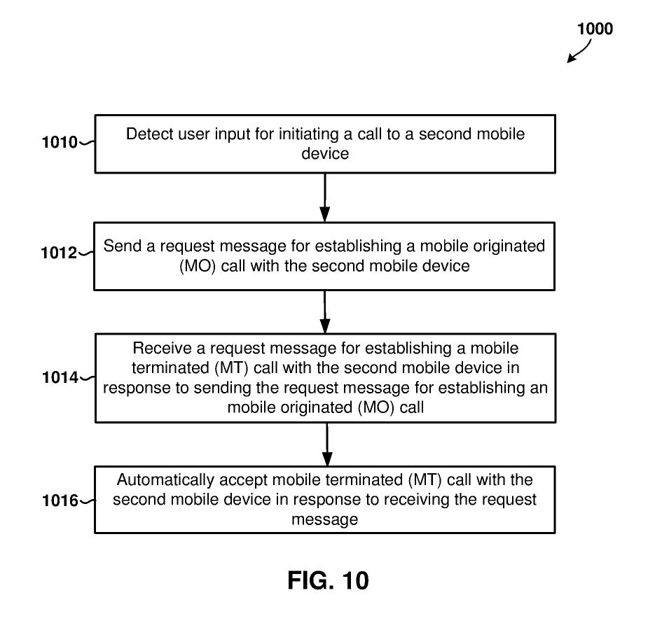

FIG. 10 illustrates a method 1000 that may be implemented by a mobile device attempting to place a MO call and receiving a MT call in response from a mobile device implementing an embodiment. The method 1000 may be performed by a processor in a mobile device (e.g., first mobile device 110 in FIG. 1, Device 1 in FIG. 3, 1^{st} Device 410 in FIG. 4, etc.).

In block 1010, the mobile device may detect a user input for initiating a call to another mobile device (e.g., second mobile device 120 in FIG. 1, Device 2 in FIG. 3, 2nd Device 420 in FIG. 4, etc.). In block 1012, the mobile device may send a request message to the network for establishing a mobile originated (MO) call with the other mobile device. In block 1014, the mobile device may receive a request message from the network that includes information for establishing a mobile terminated (MT) call with the other mobile device in response to sending the request message for establishing a MO call. In response to receiving the request message in block 1014, the mobile device may automatically accept MT call with the other mobile device in block 1016.

FIG. 11 illustrates an example Evolved Packet System (EPS), Long Term Evolution (LTE) or evolved universal terrestrial radio access network (E-UTRAN) communication network 1100 in which the various embodiments may be implemented. In the example illustrated in FIG. 11, the communication network 1100 includes mobile devices 1102, base stations 1104, and various network components 1106 for communicating with a packet data network (PDN) 1108 and ultimately the Internet 1110. The PDN 1108 may include an operator internet protocol (IP) services network, an Intranet, an IP multimedia subsystem (IMS), a PS streaming service (PSS) network, etc. In some embodiments, the base stations 1104 and various network components 1106 may be included as part of the network 130 illustrated in FIG. 1 and described with reference to FIGS. 1-4.

The mobile devices 1102 may be configured to transmit and receive voice, data, and control signals to and from the base stations 1104 via wireless communication links 1112. The base stations 1104 may include an evolved Node B (eNodeB), a remote radio head (RRH), a femto cell, pico cell, micro cell, a base transceiver station (BTS), a radio base station, a radio transceiver, a transceiver function, a basic service set (BSS), an extended service set (ESS), etc.

The base stations 1104 may be configured to provide user plane (e.g., PDCP, RLC, MAC, PHY) and control plane (RRC) protocol terminations towards the mobile devices 1102. The base stations 1104 may act as a bridge (e.g., layer 2 bridge) between the mobile devices 1102 and the network components 1106 by serving as the termination point of all radio protocols towards the mobile devices 1102, and relaying voice (e.g., VoIP, etc.), data, and control signals to the network components 1106 in the core network. The base stations 1104 may also be configured to perform various radio resource management operations, such as controlling the usage of radio interfaces, allocating resources based on requests, prioritizing and scheduling traffic according to various quality of service (QoS) requirements, and monitoring the usage of network resources. In addition, the base stations 1104 may be configured to collect radio signal level measurements, analyze the collected radio signal level measurements, and handover mobile devices 1102 (or connections to the mobile devices) to other base stations 1104 (e.g., a second eNodeB) based on the results of the analysis.

The network components 1106 may include various logical and/or functional components that serve as the primary point of entry and exit of mobile device traffic and/or connect the mobile devices 1102 to their immediate service provider, the PDN 1108 and ultimately the Internet 1110. The network components 1106 may be configured to forward the voice, data, and control signals to other components in the core network as user data packets, provide connectivity to external packet data networks, manage and store contexts (e.g. network internal routing information, etc.), and act as an anchor between different technologies (e.g., 3GPP and non-3GPP systems). The network components 1106 may also coordinate the transmission and reception of data to and from the Internet 1110, as well as the transmission and reception of voice, data and control information to and from an external service network, the PDN 1108, other base stations 1104, and to other mobile devices 1102.

In the example illustrated in FIG. 11, data transmitted from the mobile devices 1102 is received by a base station 1104 (eNodeB). The base station 1104 may send signaling/control information (e.g., information pertaining to call setup, security, authentication, etc.) to a mobility management entity (MME) 1118. The MME 1118 may request user/subscription information from a home subscriber server (HSS) 1120, perform various administrative tasks (e.g., user authentication, enforcement of roaming restrictions, etc.), and send authorization and administrative information to the signaling gateway (SGW) 1114 and/or the base station 1104. The base station 1104 may receive authorization information from the MME 1118 (e.g., an authentication complete indication, an identifier of a selected SGW, etc.), and send data received from the mobile device 1102 to the SGW 1114. The SGW 1114 may store information about the received data (e.g., parameters of the IP bearer service, etc.) and forward user data packets to a packet data network gateway (P-GW) 1116, which facilitates communications with the PDN 1108 and ultimately the Internet 1110.

The base stations 1104 may be configured to manage the scheduling and transmission of paging messages originated from the MME 1118, the scheduling and transmission of broadcast information originated from the MME 1118, and the scheduling and transmission of public warning system (e.g., earthquake and tsunami warning system, commercial mobile alert service, etc.) messages originated from the MME 1118.

The base stations 1104 may be connected to the other base stations 1104 via an X2 interface/protocol. The base stations 1104 may be configured to communicate with the SGW 1114 and/or MME 1118 via the Si interface/protocol.

The MME 1118 may be configured to perform various operations to provide various functions, including non-access stratum (NAS) signaling, NAS signaling security, access stratum (AS) security control, inter-CN node signaling for mobility between 3GPP access networks, idle mode UE reach-ability (including control and execution of paging retransmission), tracking area list management (e.g., for a mobile device in idle and active mode), PGW and SGW selection, MME selection for handovers with MME change, serving GPRS support node (SGSN) selection for handovers to 2G or 3G 3GPP access networks, roaming, authentication, bearer management functions including dedicated bearer establishment, support for public warning system (e.g., earthquake and tsunami warning system, commercial mobile alert service, etc.) message transmission, and performing paging optimization.

The various embodiments may be implemented on a number of single processor and multiprocessor computer systems, including a system-on-chip (SOC) or system in a package (SIP). FIG. 12 illustrates an example computing system or SIP 1200 architecture that may be used in mobile devices (e.g., mobile devices 110, 120 illustrated in FIG. 1, Devices 1 and 2 illustrated in FIG. 3, 1^{st} and 2^{nd} Devices 410, 420 illustrated in FIG. 4, etc.) implementing the various embodiments.

In the example, illustrated in FIG. 12, the SIP 1200 includes a two SOCs 1202, 1204, a clock 1206, and a voltage regulator 1208. In some embodiments, the first SOC 1202 operates as central processing unit (CPU) of the mobile device that carries out the instructions of software application programs by performing the arithmetic, logical, control and input/output (I/O) operations specified by the instructions. In some embodiments, the second SOC 1204 may operate as a specialized processing unit. For example, the second SOC 1204 may operate as a specialized 5G processing unit responsible for managing high volume, high speed (e.g., 5 Gbps, etc.), and/or very high frequency short wave length (e.g., 28 GHz mmWave spectrum, etc.) communications.

In the example illustrated in FIG. 12, the first SOC 1202 includes a digital signal processor (DSP) 1210, a modem processor 1212, a graphics processor 1214, an application processor 1216, one or more coprocessors 1218 (e.g., vector co-processor) connected to one or more of the processors, memory 1220, custom circuity 1222, system components and resources 1224, an interconnection/bus module 1226, and a thermal management unit 1232. The second SOC 1204 includes a 5G modem processor 1252, a power management unit 1254, an interconnection/bus module 1264, a plurality of mmWave transceivers 1256, memory 1258, and various additional processors 1260, such as an applications processor, packet processor, etc.

Each processor 1210, 1212, 1214, 1216, 1218, 1252, 1260 may include one or more cores, and each processor/core may perform operations independent of the other processors/cores. For example, the first SOC 1202 may include a processor that executes a first type of operating system (e.g., FreeBSD, LINUX, OS X, etc.) and a processor that executes a second type of operating system (e.g., MICROSOFT WINDOWS 10). In addition, any or all of the processors 1210, 1212, 1214, 1216, 1218, 1252, 1260 may be included as part of a processor cluster architecture (e.g., a synchronous processor cluster architecture, an asynchronous or heterogeneous processor cluster architecture, etc.).

The first and second SOC 1202, 1204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 1224 of the first SOC 1202 may include power amplifiers, voltage regulators, oscillators, phase-locked loops, peripheral bridges, data controllers, memory controllers, system controllers, access ports, timers, and other similar components used to support the processors and software clients running on a mobile device. The system components and resources 1224 and/or custom circuitry 1222 may also include circuitry to interface with peripheral devices, such as cameras, electronic displays, wireless communication devices, external memory chips, etc.

The first and second SOC 1202, 1204 may communicate via an interconnection/bus module 1250. The processors 1210, 1212, 1214, 1216, 1218, may be interconnected to one or more memory elements 1220, system components and resources 1224, and custom circuitry 1222 via an interconnection/bus module 1226. Similarly, the processors 1252, 1260 may be interconnected to the power management unit 1254, the mmWave transceivers 1256, memory 1258, and various additional processors 1260 via the interconnection/bus module 1264. The interconnection/bus module 1226, 1250, 1264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 1202, 1204 may further include an input/output module (not illustrated) for communicating with resources external to the SOC, such as a clock 1206 and a voltage regulator 1208. Resources external to the SOC (e.g., clock 1206, voltage regulator 1208) may be shared by two or more of the internal SOC processors/cores.

In addition to the SIP 1200 discussed above, the various embodiments may be implemented in a wide variety of computing systems, which may include a single processor, multiple processors, multicore processors, or any combination thereof.

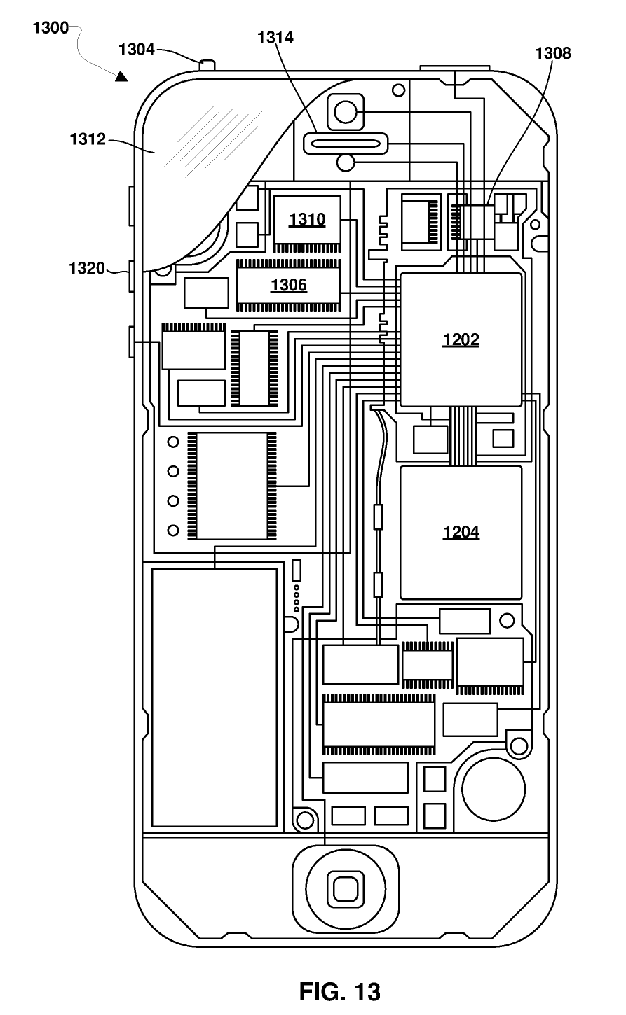

The various embodiments may be implemented on a variety of computing system, an example of which is illustrated in FIG. 13 in the form of a smartphone. A smartphone 1300 may include a first SOC 1202 (e.g., a SOC-CPU) coupled to a second SOC 1204 (e.g., a 5G capable SOC). The first and second SOCs 1202, 1204 may be coupled to internal memory 1306, a display 1312, and to a speaker 1314. Additionally, the smartphone 1300 may include an antenna 1304 for sending and receiving electromagnetic radiation that may be connected to a wireless data link and/or cellular telephone transceiver 1308 coupled to one or more processors in the first and/or second SOCs 1202, 1204. Smartphones 1300 typically also include menu selection buttons or rocker switches 1320 for receiving user inputs.

A typical smartphone 1300 also includes a sound encoding/decoding (CODEC) circuit 1310, which digitizes sound received from a microphone into data packets suitable for wireless transmission and decodes received sound data packets to generate analog signals that are provided to the speaker to generate sound. Also, one or more of the processors in the first and second SOCs 1202, 1204, wireless transceiver 1308 and CODEC 1310 may include a digital signal processor (DSP) circuit (not shown separately).

Those of skill in the art will appreciated that information and signals may be represented using any of a variety of different technologies and techniques. For example, data, instructions, commands, information, signals, bits, symbols, and chips that may be referenced throughout the preceding description may be represented by voltages, currents, electromagnetic waves, magnetic fields or particles, optical fields or particles, or any combination thereof.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a processor of a mobile device and the processor may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The processors described in the preceding description may be any programmable microprocessor, microcomputer or multiple processor chip or chips that can be configured by software instructions (applications) to perform a variety of functions, including the functions of various embodiments described above. In some devices, multiple processors may be provided, such as one processor dedicated to wireless communication functions and one processor dedicated to running other applications. Typically, software applications may be stored in the internal memory before they are accessed and loaded into the processors. The processors may include internal memory sufficient to store the application software instructions. In many devices the internal memory may be a volatile or nonvolatile memory, such as flash memory, or a mixture of both. For the purposes of this description, a general reference to memory refers to memory accessible by the processors, including internal memory or removable memory plugged into the device and memory within the processor, themselves.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 900, 950 and 1000 may be substituted for or combined with one or more operations of the methods 800, 900, and 950, and vice versa.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The foregoing description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the claims are not intended to be limited to the embodiments shown herein but are to be accorded the widest scope consistent with the language of the claims and the principles and novel features disclosed herein.

What is claimed is:

1. A method of converting a mobile terminated (MT) call to a mobile originated (MO) call, comprising:
receiving, by a second mobile device from a network, a first paging request associated with a first service request for establishing a first MT call from a first mobile device;
activating, in the second mobile device, a user interface feature for converting the first MT call from the first mobile device to a first MO call from the second mobile device to the first mobile device;
sending to the network, from the second mobile device, a disconnect message such that the first MT call is promptly terminated;
sending to the network, from the second mobile device, a second service request for a second MO call to the first mobile device; and
establishing the second MO call at the second mobile device.

2. The method of claim 1, further comprising:
sending to the network, from the first mobile device, the first service request for establishing the first MO call at the first mobile device;
receiving from the network, by the first mobile device, a normal disconnect in response to sending the first service request for establishing the first MO call at the first mobile device; and
receiving from the network, by the first mobile device, a second paging request associated with the second service request to establish a second MT call by the first mobile device with the second mobile device.

3. The method of claim 2, further comprising automatically accepting the second MT call by the first mobile device in response to receiving the second paging request associated with the second MT call after sending the first service request for establishing the first MO call.

4. The method of claim 1, wherein sending the disconnect message such that the first MT call is promptly terminated comprises:
sending a call control disconnect message with a normal clearing cause code; and
sending a call control release message.

5. The method of claim 1, wherein sending the disconnect message such that the first MT call is promptly terminated comprises:
releasing a radio resource control (RRC) connection associated with the first MT call in response activating the user interface feature for converting the first MT call at the second mobile device to the second MO call to the first mobile device.

6. The method of claim 1, wherein activating the user interface feature for converting the first MT call from the first mobile device to a first MO call from the second mobile device to the first mobile device comprises:
displaying a user interface button configured to generate user input for trigging a conversion of an MT call to a MO call.

7. The method of claim 6, wherein sending the disconnect message to the network is performed in response to receiving a user input from the displayed user interface button.

8. The method of claim 6, wherein displaying the user interface button configured to generate the user input for trigging the conversion of the MT call to the MO call comprises:
displaying the user interface button in response to receiving the first paging request associated with the first service request for establishing the first MT call from the first mobile device.

9. A mobile device, comprising:
a transceiver; and
a processor coupled to the transceiver and configured with processor-executable instructions to perform operations comprising:
receiving from a network a first paging request associated with a first service request for establishing a first mobile terminated (MT) call from another mobile device;
activating a user interface feature for converting the first MT call from the other mobile device to a first mobile originated (MO) call to the other mobile device;
sending a disconnect message to the network such that the first MT call is promptly terminated;
sending to the network a second service request for a second MO call to the other mobile device; and
establishing the second MO call at the mobile device.

10. The mobile device of claim 9, wherein the processor is configured with processor-executable instructions to perform operations such that the first MT call is promptly terminated comprises:
sending a call control disconnect message with a normal clearing cause code; and
sending a call control release message.

11. The mobile device of claim 9, wherein the processor is configured with processor-executable instructions to perform operations such that sending the disconnect message such that the first MT call is promptly terminated comprises:
releasing a radio resource control (RRC) connection associated with the first MT call in response activating the user interface feature for converting the first MT call at the mobile device to the second MO call to the other mobile device.

12. The mobile device of claim 9, wherein the processor is configured with processor-executable instructions to perform operations such that activating the user interface feature for converting the first MT call from the other mobile device to a first MO call to the other mobile device comprises:
displaying a user interface button configured to generate a user input for trigging a conversion of a MT call to a MO call.

13. The mobile device of claim 12, wherein the processor is configured with processor-executable instructions to perform operations such that sending the disconnect message to the network is performed in response to receiving a user input from the displayed user interface button.

14. The mobile device of claim 12, wherein the processor is configured with processor-executable instructions to perform operations such that displaying the user interface button configured to generate the user input for trigging the conversion of the MT call to the MO call comprises:
displaying the user interface button in response to receiving the first paging request associated with the first service request for establishing the first MT call from the other mobile device.

15. A mobile device, comprising:
means for receiving from a network a first paging request associated with a first service request for establishing a first mobile terminated (MT) call from another mobile device;
means for activating a user interface feature for converting the first MT call from the other mobile device to a first mobile originated (MO) to the other mobile device;
means for sending to the network a disconnect message such that the first MT call is promptly terminated;
means for sending to the network a second service request for a second MO call to the other mobile device; and
means for establishing the second MO call.

16. The mobile device of claim 15, wherein means for sending the disconnect message such that the first MT call is promptly terminated comprises:
means for sending a call control disconnect message with normal a clearing cause code; and
means for sending a call control release message.

17. The mobile device of claim 15, wherein means for sending the disconnect message such that the first MT call is promptly terminated comprises:
means for releasing a radio resource control (RRC) connection associated with the first MT call in response activating the user interface feature for converting the first MT call at the other mobile device to the second MO call to the other mobile device.

18. The mobile device of claim 15, wherein means for activating the user interface feature for converting the first MT call from the other mobile device to a first MO to the other mobile device comprises:
means for displaying a user interface button configured to generate user input for trigging a conversion of an MT call to a MO call.

19. The mobile device of claim 18, wherein means for sending the disconnect message to the network comprises means for sending the disconnect message to the network in response to receiving a user input from the displayed user interface button.

20. The mobile device of claim 18, wherein means for displaying the user interface button configured to generate the user input for trigging the conversion of the MT call to the MO call comprises:
means for displaying the user interface button in response to receiving the first paging request associated with the first service request for establishing the first MT call from the other mobile device.

21. A non-transitory processor-readable storage medium having stored thereon processor-executable instructions configured to cause a processor of a mobile device to perform operations for converting a mobile terminated (MT) call to a mobile originated (MO) call, comprising:
receiving from a network a first paging request associated with a first service request for establishing a first MT call from another mobile device;
activating a user interface feature for converting the first MT call from the other mobile device to a first MO call to the other mobile device;
sending a disconnect message such that a user busy response is not invoked;
sending a second service request for establishing a second MO call to the other mobile device; and
establishing the second MO call.

22. The non-transitory processor-readable storage medium of claim 21, wherein the stored processor-executable instructions are configured to cause the processor of the mobile device to perform operations such that sending the disconnect message such that the user busy response is not invoked comprises:
sending a call control disconnect message with a normal clearing cause code to a base station; and
sending a call control release message to the base station.

23. The non-transitory processor-readable storage medium of claim 21, wherein the stored processor-executable instructions are configured to cause the processor of the mobile device to perform operations such that sending the disconnect message such that the user busy response is not invoked comprises:
releasing a radio resource control (RRC) connection associated with the first MT call in response to activating the user interface feature for converting the first MT call to the second MO call to the other mobile device.

24. The non-transitory processor-readable storage medium of claim 21, wherein the stored processor-executable instructions are configured to cause the processor of the mobile device to perform operations such that activating the user interface feature for converting the first MT call from the other mobile device to a first MO call to the other mobile device comprises:
displaying a user interface button configured to generate user input for trigging a conversion of an MT call to a MO call.

25. The non-transitory processor-readable storage medium of claim 24, wherein the stored processor-executable instructions are configured to cause the processor of the mobile device to perform operations such that sending the disconnect message to the network is performed in response to receiving a user input from the displayed user interface button.

26. The non-transitory processor-readable storage medium of claim 24, wherein the stored processor-executable instructions are configured to cause the processor of the mobile device to perform operations such that displaying the user interface button configured to generate the user input for trigging the conversion of the MT call to the MO call comprises:
displaying the user interface button in response to receiving the first paging request associated with the first service request for establishing the first MT call from the other mobile device.
